(19) United States
(12) Patent Application Publication
(10) Pub. No.: US 2024/0278446 A1
(43) Pub. Date: Aug. 22, 2024

(54) DEVICE FOR FLATTENING, CONVEYING AND CUTTING METAL WIRES INTO GRANULES

(71) Applicant: DONGGUAN SIBEIFU INTELLIGENT TECHNOLOGY CO., LTD., Dongguan (CN)

(72) Inventor: Qi Lu, Dongguan (CN)

(21) Appl. No.: 18/648,673

(22) Filed: Apr. 29, 2024

(30) Foreign Application Priority Data
Sep. 18, 2023 (CN) 2023112043810

(51) Int. Cl. B26D 5/00; B26D 7/01; B65H 51/32

(52) U.S. Cl. CPC B26D 5/007; B26D 7/01; B65H 51/32

(57) ABSTRACT

A device for flattening, conveying and cutting metal wires into granules is provided. The flattening and feeding mechanism horizontally feeds a metal wire after flattened to the conveying and cutting mechanism, and the conveying and cutting mechanism advances the metal wire and cut into granules. The flattening and feeding mechanism includes a pressing wheel assembly, a swinging member and an output guide wheel. The swinging member is pressed and rotated as the metal wire is driven towards the conveying and cutting mechanism, and the second end of the swinging member deviates from the photoelectric sensor so as to trigger the photoelectric sensor, thereby actuating the pressing wheel assembly to flatten and output the metal wire. The device can prevent wire bending and feeding blockage during wire conveying.

### FIELD OF THE INVENTION

The present invention relates to the technical field of metal wire processing, and particularly to a device for flattening, conveying and cutting metal wires into granules.

### BACKGROUND OF THE INVENTION

Tin granules and the like are often used as conductive connections between electronic components, typically achieved through soldering. Tin granules are usually small in size, and during processing, tin wires need to be cut into individual granules. In existing technology, metal granulating equipment is used to produce tin granules, which generally includes a feeding mechanism at the rear and a conveying and cutting mechanism at the front. The current feeding mechanism and the conveying and cutting mechanism are separately located in far distance, and since the tin wires are thin and soft, there is a risk of bending during forward conveying, which leads to feeding blockage. Additionally, to achieve automatic feeding, a manipulator is provided above the conveying and cutting mechanism for picking the tin granules based on a trigger action. However, there is a common occurrence of false triggering in the current device, causing the manipulator to mistakenly operate.

Therefore, there is an urgent need for providing a device for flattening, conveying and cutting metal wires into granules which prevents wire bending and feeding blockage during wire conveying.

### SUMMARY OF THE INVENTION

The object of the present invention is to provide a device for flattening, conveying and cutting metal wires into granules which prevents wire bending and feeding blockage during wire conveying.

To achieve the above-mentioned objectives, the present invention provides a device for flattening, conveying and cutting metal wires into granules, including a flattening and feeding mechanism at a rear end and a conveying and cutting mechanism at a front end. The flattening and feeding mechanism is configured to horizontally feed a metal wire after flattened to the conveying and cutting mechanism, and the conveying and cutting mechanism is configured to advance the metal wire and cut into granules. The flattening and feeding mechanism comprises a pressing wheel assembly, a swinging member and an output guide wheel arranged sequentially from rear to front, and a photoelectric sensor. The swinging member is rotatably arranged, and a first end of the swinging member is close to the pressing wheel assembly and equipped with an input guide wheel. The photoelectric sensor is aligned with a second end of the swinging member. The metal wire outputted from the pressing wheel assembly passes through the input guide wheel and the output guide wheel successively before entering the conveying and cutting mechanism, the swinging member is pressed and rotated as the metal wire is driven towards the conveying and cutting mechanism, and the second end of the swinging member deviates from the photoelectric sensor so as to trigger the photoelectric sensor, thereby actuating the pressing wheel assembly to flatten and output the metal wire.

In a preferable embodiment, the swinging member is bent and includes a first portion and a second portion, the first portion is horizontally arranged, and the second portion is inclined upwards, the swinging member is pivotally mounted on a frame at a connection between the first portion and the second portion, the input guide wheel is rotatably mounted at an end of the second portion, and the photoelectric sensor is aligned with an end of the first portion.

In a preferable embodiment, the photoelectric sensor is a slot-type photoelectric switch with a detection opening, and a protrusion is extended from the end of the first portion for inserting into the detection opening.

In a preferable embodiment, an elastic member is installed between the second portion and the frame, and has a constant tendency to drive the second portion to rotate upward.

In a preferable embodiment, the elastic member is located below the second portion, and the second portion is provided with a mounting hole, through which a top of the elastic member passes.

In a preferable embodiment, the flattening and feeding mechanism further includes a guide rod positioned above the swinging member and located between the input guide wheel and the output guide wheel; and the metal wire outputted by the pressing wheel assembly passes upward over the input guide wheel, then downward past the guide rod, and then upward over the output guide wheel.

In a preferable embodiment, the guide rod is positioned directly above the connection between the first portion and the second portion, and below a line connecting the input guide wheel and the output guide wheel.

In a preferable embodiment, the input guide wheel and the output guide wheel each are provided with a receiving groove for receiving the metal wire.

In a preferable embodiment, the flattening wheel assembly includes a driver, an upper pressing wheel, and a lower pressing wheel, with the upper pressing wheel positioned directly above the lower pressing wheel and both being close to each other; the driver is configured to drive one of the upper pressing wheel and the lower pressing wheel to rotate, and also drive the other of the upper pressing wheel and the lower pressing wheel to rotate, with the metal wire passing between the upper pressing wheel and the lower pressing wheel.

In a preferable embodiment, a worm is connected to the output end of the driver, and a worm gear is installed on one side of the lower pressing wheel, for engaging with the worm for transmission.

In a preferable embodiment, diameters of the upper pressing wheel and the lower pressing wheel are equal, and the upper pressing wheel is provided with an upper pressing groove and the lower pressing wheel is provided with a lower pressing groove.

In a preferable embodiment, the device further includes a fetching device positioned above the conveying and cutting mechanism, wherein the conveying and cutting mechanism includes a conveyor device, a positioning and cutting device, and a photoelectric sensor; the conveyor device is configured to sequentially convey the metal wire from left to right into the positioning and cutting device, and the positioning and cutting device is configured to cut the metal wire into metal granules; the photoelectric sensor is positioned above the conveyor device and the positioning and cutting device, while the fetching device is positioned directly above the positioning and cutting device; the photoelectric sensor is triggered when the fetching device moves downward to fetch the metal wire, thereby actuating the positioning and cutting device to cut the metal wire into metal granules, which are then removed by the fetching device.

In a preferable embodiment, a top of the conveyor device is provided with a first channel, and a top of the positioning and cutting device is provided with a second channel, with the first channel and the second channel being directly connected.

In a preferable embodiment, the photoelectric sensor includes a receiver positioned behind the conveyor device and a transmitter positioned in front of the positioning and cutting device, with the transmitter aligned with the second channel and the receiver aligned with the first channel.

In a preferable embodiment, the conveying and cutting mechanism further includes a driving device positioned below the conveyor device and the positioning and cutting device, the driving device is configured to switch the conveyor device between clamping and unclamping states, drive the conveyor device to move forwards and backwards, and further switch the positioning and cutting device between unclamping, clamping, and cutting states.

In a preferable embodiment, the positioning and cutting device is provided with a cutting channel allowing for the metal wire to pass; the cutting channel can be expanded and narrowed, the cutting channel is expanded when the positioning and cutting device is in the unclamping state, and is narrowed when the positioning and cutting device is in the clamping and cutting states.

In a preferable embodiment, the positioning and cutting device includes a driven member, a lower clamping member, an upper cutter, and a lower cutter, the lower clamping member is mounted on the driven member and positioned directly below the upper cutter; a cutting channel is defined between the upper cutter and the lower clamping member; the lower cutter is mounted on the driven member and located at a right of the lower clamping member; the upper cutter and the lower cutter are arranged in a staggered manner, with the second channel positioned at a top of the upper cutter; the driving device drives the driven member to move upward, bringing the lower clamping member closer to the upper cutter, thereby narrowing the cutting channel; when the driven member continues to move upward, the lower cutter is driven to cut the metal wire protruding from the cutting channel.

In a preferable embodiment, the lower clamping member is provided with a sliding cavity, the driven member is provided with a connecting structure extended into the sliding cavity, a sliding rod is installed in the sliding cavity, the connecting structure is slidably mounted on the sliding rod, the sliding rod is sleeved with a spring, the spring is located between the lower clamping member and the connecting structure, and the spring constantly tends to drive the connecting structure to slide downward.

In a preferable embodiment, a mounting slot is provided at the rear end of the upper cutter, a limit plate is detachably installed in the mounting slot, and the limit plate is provided with limiting through-holes allowing for the metal wire to pass through from front to back.

In a preferable embodiment, the conveyor device includes an upper clamping member, a support base, and a sliding member, the upper clamping member is slidably mounted on the support base, a spring member is installed between the upper clamping member and the support base, a clamping channel that can be expanded and narrowed is defined between the upper clamping member and the support base, the spring member constantly tends to drive the upper clamping member and the support base closer to each other to narrow the clamping channel, the upper clamping member is slidably mounted on the sliding member for forward and backward movements, the driving device is configured to drive the sliding member upward to move the upper clamping member upward to expand the clamping channel, and the driving device is connected to the support base and configured to drive the support base to move synchronously with the upper clamping member for forward and backward movements.

In a preferable embodiment, the driving device includes a drive motor and a camshaft, and the camshaft is installed on an output end of the drive motor, and is driven to rotate by the drive motor. The camshaft is axially arranged with a first cam, a second cam, and a third cam, the support base is pressed against the first cam through a first roller, the upper clamping member is pressed against the second cam through a second roller, and the driven member is pressed against the third cam through a third roller. The drive motor drives the camshaft to rotate, thereby pushing the conveyor device for forward and backward movement via the first cam, pushing the upper clamping member for up and down movement via the second cam, and pushing the driven member for up and down movement via the third cam.

In the present invention, the swinging member and the output guiding wheel are configured between the pressing wheel assembly and the conveying and cutting mechanism and the section of the metal wire between the pressing wheel assembly and the conveying and cutting mechanism is supported and limited by the input guiding wheel and the output guiding wheel, for preventing the metal wire from moving and twisting, thereby ensuring that the metal wire outputted is straight and flattened, without any twisting or bending. In such a way, the problem of feeding blockage caused by twisting and bending of the metal wire during wire feeding and conveying is solved. Additionally, due to the presence of the swinging member and the output guiding wheel, the flattening and feeding mechanism can be positioned close to the conveying and cutting mechanism, which is conducive to achieving a compact layout of the device for flattening, conveying and cutting metal wire into granules.

### BRIEF DESCRIPTION OF THE DRAWINGS

FIG. 1 is a perspective view of the device for flattening, conveying and cutting metal wires into granules of the present invention.

FIG. 2 is a perspective view of the device for flattening, conveying and cutting metal wires into granules of the present invention, with frame and partial structure hidden.

FIG. 3 is a perspective view of the device for flattening, conveying and cutting metal wires into granules shown in FIG. 2 at another angle.

FIG. 4 is a front view of the device for flattening, conveying and cutting metal wires into granules shown in FIG. 2.

FIG. 5 is a perspective view of the flattening and feeding mechanism of the present invention.

FIG. 6 is a perspective view of the flattening and feeding mechanism of the present invention at another angle.

FIG. 7 is a perspective view of the conveying and cutting mechanism of the present invention.

FIG. 8 is a front view of the conveying and cutting mechanism of the present invention.

FIG. 9 is a perspective view of the positioning and cutting device of the present invention.

FIG. 10 is a perspective view of the positioning and cutting device of the present invention at another angle.

FIG. 11 is a front view of the positioning and cutting device of the present invention.

FIG. 12 is a sectional view obtained by cutting along line A-A in FIG. 11.

FIG. 13 is an exploded perspective view of the positioning and cutting device of the present invention.

FIG. 14 is a perspective view of the conveyor device of the present invention.

FIG. 15 is a front view of the conveyor device of the present invention.

FIG. 16 is a perspective view of the conveyor device of the present invention at another angle.

FIG. 17 is a left view of the conveyor device of the present invention.

FIG. 18 is a sectional view obtained by cutting along line B-B in FIG. 17.

FIG. 19 is an exploded perspective view of the conveyor device of the present invention.

FIG. 20 is a schematic diagram of the processing flow of the conveying and cutting mechanism of the present invention.

### DETAILED DESCRIPTION OF ILLUSTRATED EMBODIMENTS

In order to further illustrate the technical content and structural features of the present invention, the following detailed description is provided in conjunction with the embodiments and with reference to the drawings.

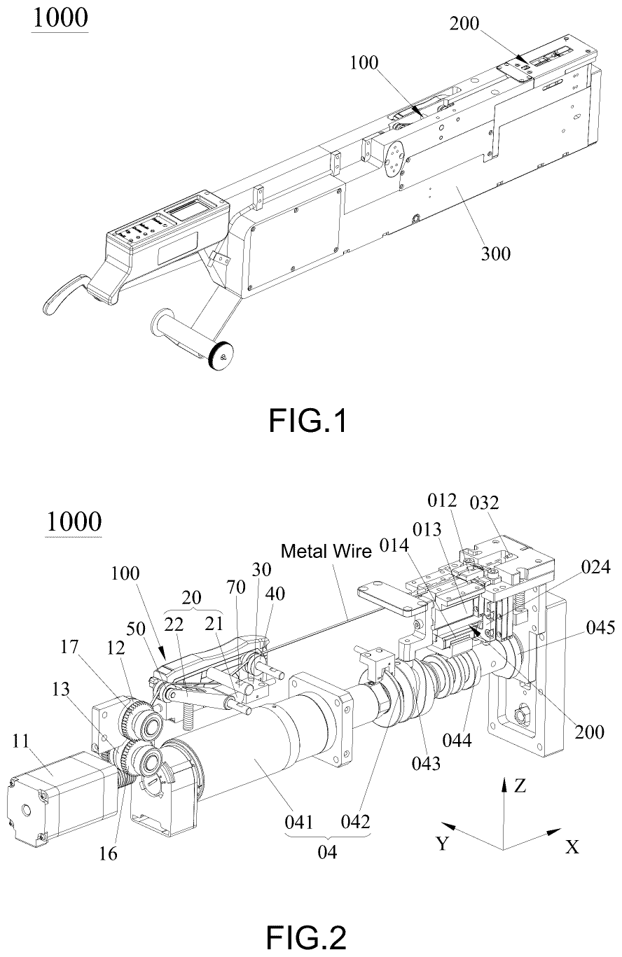

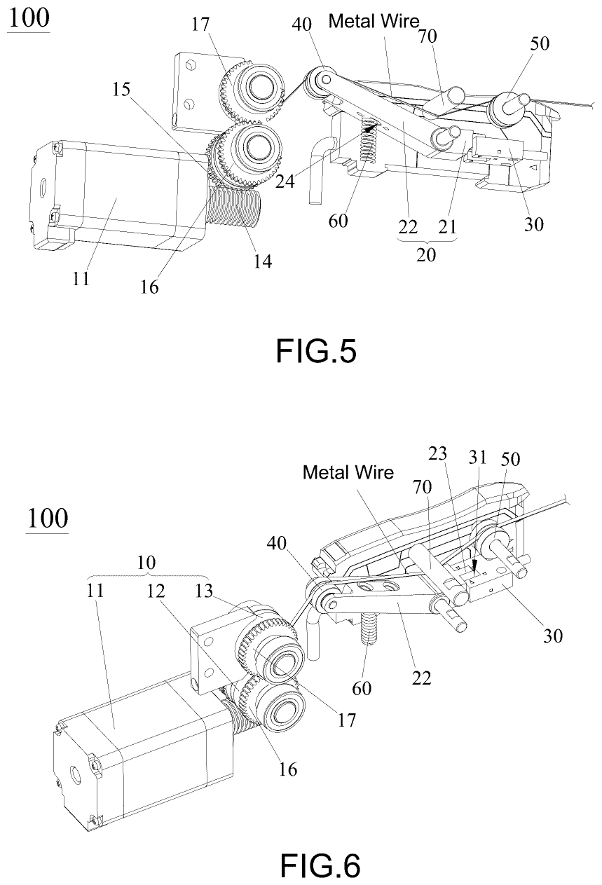

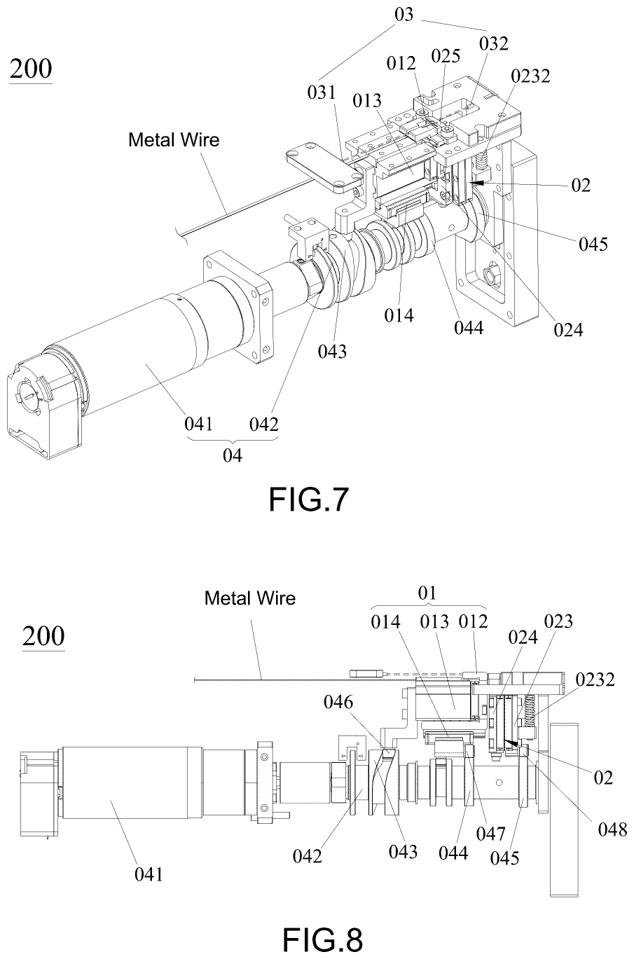

As shown in FIGS. 1 to 8, the present invention provides a device 1000 for flattening, conveying and cutting metal wires into granules, which is suitable for cutting the metal wires into metal granules having small size. For example, the metal granules may be tin granules or copper granules. Tin granules are generally used as conductors between electronic components, for achieving electrical connections of electronic components by melting. It is understood that the tin wire is prone to bending during transportation due to its soft nature and small diameter, which leads to wire feeding blockage. In view of this, the present invention aims to solve this problem.

The device 1000 for flattening, conveying and cutting metal wires into granules of the present invention includes a flattening and feeding mechanism 100 located at the rear end and a conveying and cutting mechanism 200 located at the front end. The flattening and feeding mechanism 100 is configured to horizontally feed the metal wire after flattened to the conveying and cutting mechanism 200. The conveying and cutting mechanism 200 is configured to advance the metal wire and cut it into granules. The flattening and feeding mechanism 100 includes a pressing wheel assembly 10, a swinging member 20, a photoelectric sensor 30, and an output guiding wheel 40. The pressing wheel assembly 10, the swinging member 20, and the output guiding wheel 40 are sequentially arranged from rear to front. The swinging member 20 is rotatably arranged. A first end of the swinging member 20 is close to the pressing wheel assembly 10, and an input guiding wheel 50 is installed at the first end of the swinging member 20. The photoelectric sensor 30 is aligned with a second end of the swinging member 20. The metal wire outputted by the pressing wheel assembly 10 passes through the input guiding wheel 50 and the output guiding wheel 40 successively before entering the conveying and cutting mechanism 200. The swinging member 20 is pressed and rotated as the metal wire is driven towards the conveying and cutting mechanism 200, and the second end of the swinging member 20 deviates from the photoelectric sensor 30, causing the photoelectric sensor 30 to be triggered, thereby actuating the pressing wheel assembly 10 to flatten and output the metal wire.

In the present invention, the swinging member 20 and the output guiding wheel 40 are configured between the pressing wheel assembly 10 and the conveying and cutting mechanism 200, and the section of the metal wire between the pressing wheel assembly 10 and the conveying and cutting mechanism 200 is supported and limited by the input guiding wheel 50 and the output guiding wheel 40, for preventing the metal wire from moving and twisting, thereby ensuring that the metal wire outputted is straight and flattened, without any twisting or bending. In such a way, the problem of feeding blockage caused by twisting and bending of the metal wire during wire feeding and conveying is solved. Additionally, due to the presence of the swinging member 20 and the output guiding wheel 40, the flattening and feeding mechanism 100 can be positioned close to the conveying and cutting mechanism 200, which is conducive to achieving a compact layout of the device 1000 for flattening, conveying and cutting metal wire into granules.

It should be noted that, when the conveying and cutting mechanism 200 advances the metal wire forward, the advancing distance of the metal wire is the desired length of the tin granulate. Generally, the advancing distance for each advance is small, therefore the wire is tightened during the process, causing the input guiding wheel 50 to be pressed, thus causing the swinging member 20 to rotate, and then triggering the photoelectric sensor 30 rapidly to control the pressing wheel assembly 10 to flatten and discharge the metal wire. The process takes a very short time, approximately 0.04 seconds, indicating that the pressing wheel assembly 10 can timely replenish the metal wire when the conveying and cutting mechanism 200 advances the metal wire forward.

As shown in FIGS. 1 to 6, the swinging member 20 is a bent structure. The swinging member 20 includes a first portion 21 and a second portion 22. The first portion 21 is horizontally placed, and the second portion 22 is inclined upwards. The swinging member 20 is pivotally mounted on a frame 300 at the connection between the first portion 21 and the second portion 22. The input guiding wheel 50 is rotatably mounted at the end of the second portion 22, and the photoelectric sensor 30 is aligned with the end of the first portion 21. By setting the swinging member 20 to be bent, the swinging member 20 can be promptly rotated when the input guiding wheel 50 is pressed, thereby quickly triggering the photoelectric sensor 30. Preferably, the photoelectric sensor 30 is a slot-type photoelectric switch with a detection opening 31. A protrusion 23 is extended from the end of the first portion 21, and the protrusion 23 is inserted into the detection opening 31. The slot-type photoelectric switch will not be triggered when the protrusion 23 is inserted into the detection opening 31, but will be immediately triggered once the protrusion 23 is detached from the detection opening 31. The photoelectric sensor 30 is configured to determine whether the swinging member 20 is rotated by detecting whether the protrusion 23 is inserted into the detection opening 31.

Furthermore, an elastic member 60 is installed between the second portion 22 and the frame 300, which has a constant tendency to drive the second portion 22 to rotate upward. The elastic member 60 is configured to reset the rotation of the swinging member 20. To enhance the stability of the installation of the elastic member 60, the elastic member 60 is preferably located below the second portion 22, and the second portion 22 is provided with a mounting hole 24, through which the top of the elastic member 60 passes.

As shown in FIGS. 1 to 6, the flattening and feeding mechanism 100 also includes a guide rod 70. The guide rod 70 is located above the swinging member 20 and positioned between the input guide wheel 50 and the output guide wheel 40. The metal wire output by the pressing wheel assembly 10 passes upward over the input guide wheel 50, then downward past the guide rod 70, and then upward again over the output guide wheel 40. Due to the presence of the guide rod 70, the metal wire is restricted from deviating upwards, to some extent preventing twisting and bending of the metal wire. The guide rod 70 is located directly above the connection between the first portion 21 and the second portion 22, and below the line connecting the input guide wheel 50 and the output guide wheel 40. The guide rod 70 is served to amplify the movement of the metal wire.

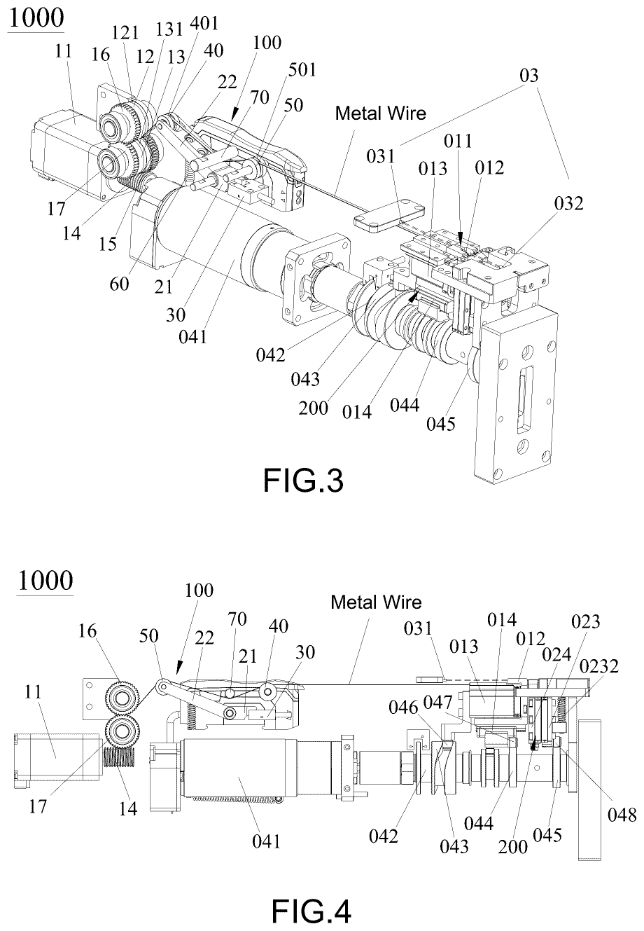

The input guide wheel 40 and the output guide wheel 50 each are provided with a receiving groove 401/501 (referring to FIG. 3) for receiving the metal wire. Once the metal wire is receiving into the receiving grooves 401 and 501, its lateral movement is restricted, thereby preventing twisting and bending due to the lateral displacement.

As shown in FIGS. 1 to 6, the pressing wheel assembly 10 includes a driver 11, an upper pressing wheel 12, and a lower pressing wheel 13. The upper pressing wheel 12 is positioned directly above the lower pressing wheel 13, and the both are close to each other. The driver 11 is configured to drive one of the upper pressing wheel 12 and the lower pressing wheel 13 to rotate, causing the other to rotate as well. The metal wire passes between the upper pressing wheel 12 and the lower pressing wheel 13, and simultaneously is flattened in the process. In this invention, the lower pressing wheel 13 is first driven to rotate by the driver 11, causing the upper pressing wheel 12 to be rotated accordingly. Optionally, depending on the actual structural layout, the upper pressing wheel 12 may be first driven to rotate by the driver 11, causing the lower pressing wheel 13 to be rotated accordingly. Metal coils are placed at the rear end of the pressing wheel assembly 10, from which the metal wire is fed to pass through the upper pressing wheel 12 and the lower pressing wheel 13.

Furthermore, a worm 14 is connected to the output end of the driver 11, and a worm gear 15 is installed on one side of the lower pressing wheel 13, for engaging with the worm 14 for transmission. A lower gear 16 is installed on the other side of the lower pressing wheel 13, and an upper gear 17 is installed on one side of the upper pressing wheel 12, for engaging with the lower gear 16 for transmission. Based on the engagement between the lower gear 16 and the upper gear 17, the transmission connection between the upper pressing wheel 12 and the lower pressing wheel 13 is achieved. Based on transmission between the worm and worm gear transmission, the driver 11 drives the lower pressing wheel 13 to rotate, thereby driving the upper pressing wheel 12 to rotate.

Preferably, the diameters of the upper pressing wheel 12 and the lower pressing wheel 13 are equal, and their linear speeds during rotation are also equal, thereby ensuring uniform press force on the metal wire for flattening. The upper pressing wheel 12 is provided with an upper pressing groove 121 (referring FIG. 3), and the lower pressing wheel 13 is provided with a lower pressing groove 131 (referring to FIG. 3), into which the metal wire is received and flattened, thereby obtaining the desired shaping effect.

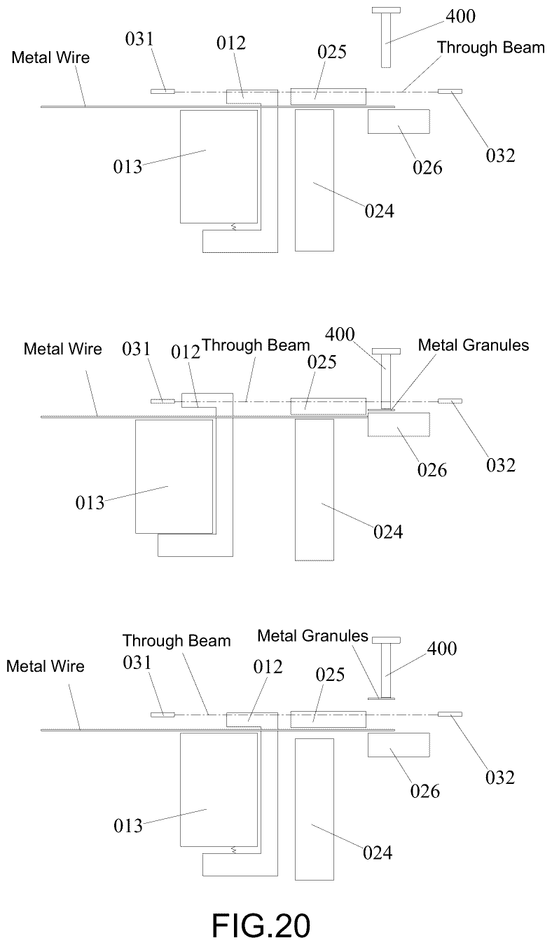

As shown in FIG. 20, the device 1000 for flattening, conveying and cutting metal wires into granules of the present invention also includes a fetching device 400 located above the conveying and cutting mechanism 200 and configured to pick up the cut tin granules by vacuum suction, or by other ways.

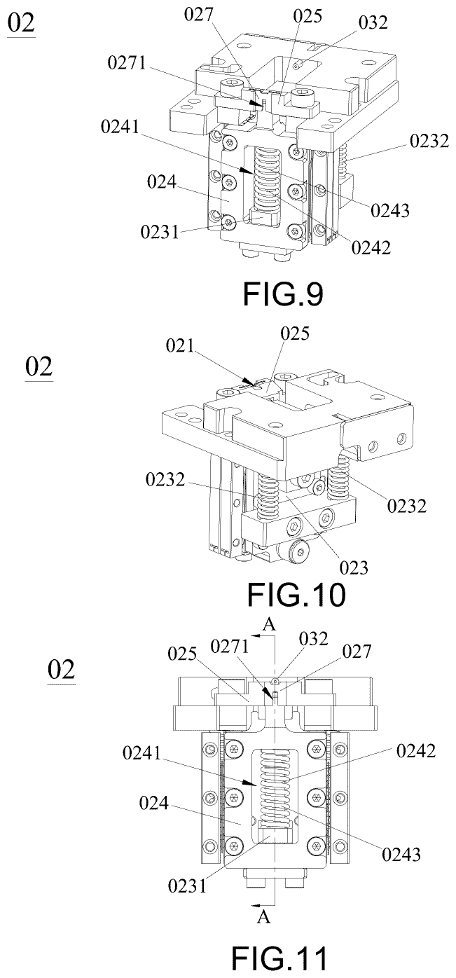

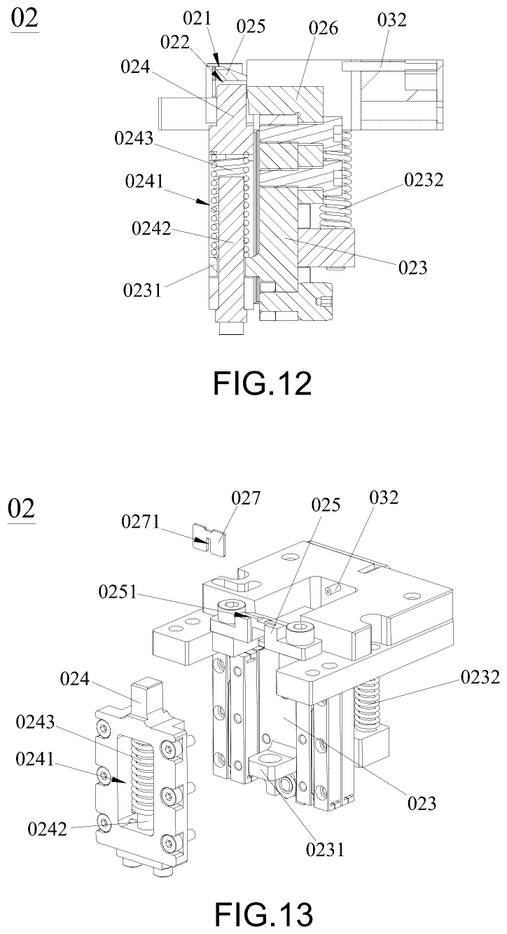

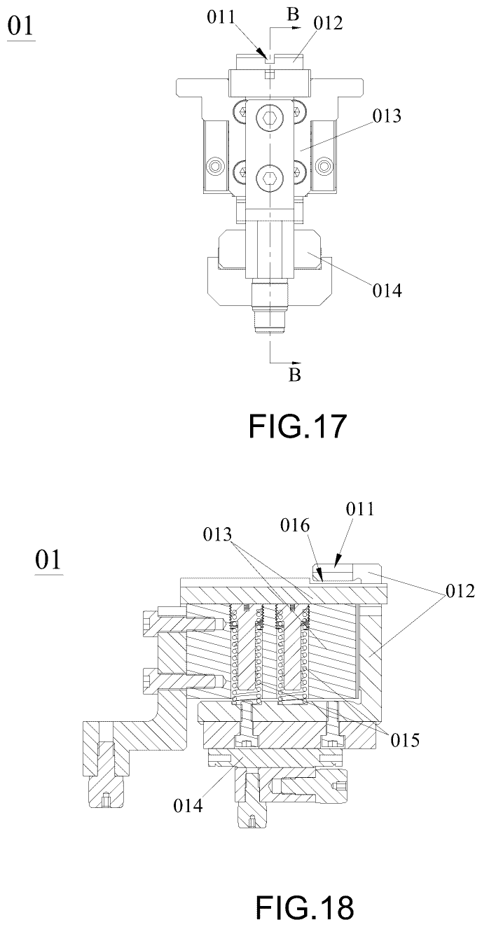

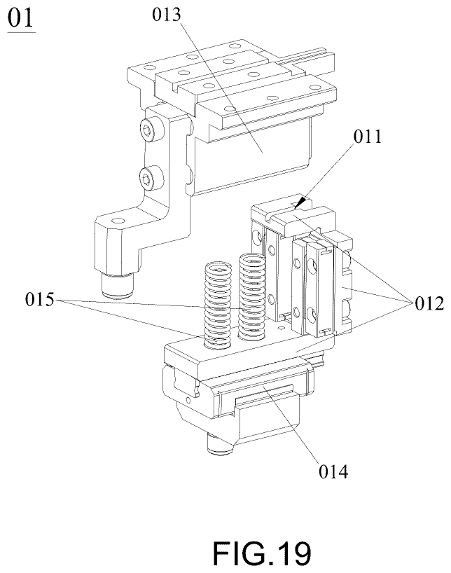

As shown in FIGS. 1 to 4 and 7 to 19, the conveying and cutting mechanism 200 of the present invention includes a conveyor device 01, a positioning and cutting device 02, and a photoelectric sensor 03. Specifically, the conveyor device 01 sequentially feeds the clamped metal wire from front to back into the positioning and cutting device 02, where the metal wire is cut into metal granules. The photoelectric sensor 03 is located above the conveyor device 01 and the positioning and cutting device 02, and the fetching device 400 is located directly above the positioning and cutting device 02. The photoelectric sensor 03 will be triggered when the fetching device 400 moves downward, thereby actuating the positioning and cutting device to cut the metal wire into metal granules, which are then removed by the fetching device 400.

In the present invention, the photoelectric sensor 03 is positioned above the conveyor device 01 and the positioning and cutting device 02. The photoelectric sensor 03 is configured to detect the action of the fetching device 400 rather than detect the metal granules. When the fetching device 400 moves downward, the photoelectric sensor 03 is triggered, indicating that the fetching device 400 is performing the action of fetching the metal granules. The positioning and cutting device 02 is actuated based on the trigger action of the photoelectric sensor 03 to cut out the metal particles which are then removed by the fetching device 400. Only after this process, the conveyor device 01 clamps the metal wire for forward feeding. In such a way, false sensing is effectively avoided thereby preventing the conveyor device 01 from incorrectly feeding the metal wire forward. Furthermore, the metal granules are immediately fetched by the fetching device 400, thereby preventing the metal granules from popping out. Meanwhile, additional structures for preventing the metal granules from popping out are eliminated, thus optimizing the structure.

As shown in FIGS. 1 to 4 and 7 to 19, the top of the conveyor device 01 is provided with a first channel 011, and the top of the positioning and cutting device 02 is provided with a second channel 021. The first channel 011 is in direct connection with the second channel 021, and the photoelectric sensor 03 is aligned with the first channel 011 and the second channel 021. When moving downward for removing the metal granules, the fetching device 400 inevitably passes through the first channel 011 and the second channel 021, therefore the photoelectric sensor 03 will be triggered.

Specifically, the photoelectric sensor 03 includes a receiver 031 positioned behind the conveyor device 01 and a transmitter 032 positioned in front of the positioning and cutting device 02. Optionally, depending on actual needs or conventional technical means in the art, the receiver 031 may be positioned in front of the positioning and cutting device 02, and correspondingly, the transmitter 032 may be positioned behind the conveyor device 01.

In the embodiments of the present invention, the transmitter 032 is aligned with the second channel 021, and the receiver 031 is aligned with the first channel 011. It is understood that when the fetching device 400 crosses the first channel 011 and the second channel 021 downward, communication between the transmitter 032 and the receiver 031 is blocked by the fetching device 400, thereby triggering the photoelectric sensor 03.

As shown in FIGS. 1 to 4 and 7 to 19, the conveying and cutting mechanism 200 further includes a driving device 04. The driving device 04 is located below the conveyor device 01 and the positioning and cutting device 02, and the driving device 04 is configured to switch the conveyor device 01 between clamping and unclamping states. The driving device 04 is further configured to drive the conveyor device 01 to move forwards and backwards, and further to switch the positioning and cutting device 02 between unclamping, clamping, and cutting states. For example, when the conveyor device 01 is in the clamping state, the metal wire is clamped, and then the driving device 04 drives the conveyor device 01 forward to advance the metal wire. When the conveyor device 01 is in the unclamping state, the driving device 04 drives the conveyor device 01 backward to reset for the next feeding stage. When the positioning and cutting device 02 is in the unclamping state, the metal wire is fed into the positioning and cutting device 02. When the positioning and cutting device 02 is in the clamping state, the metal wire is clamped. When the positioning and cutting device 02 is in the cutting state, the metal wire is cut.

As shown in FIGS. 1 to 4 and 7 to 19, the positioning and cutting device 02 is provided with a cutting channel 022 allowing for the metal wire to pass. The cutting channel 022 can be expanded and narrowed. The cutting channel 022 is expanded when the positioning and cutting device 02 is in the unclamping state, and is narrowed when the positioning and cutting device 02 is in the clamping and cutting states. It should be noted that the size of the cutting channel 022 remains substantially the same when the positioning and cutting device 02 is in the clamping and cutting states.

As shown in FIGS. 1 to 4 and 7 to 19, the positioning and cutting device 02 includes a driven member 023, a lower clamping member 024, an upper cutter 025, and a lower cutter 026. The lower clamping member 024 is installed on the driven member 023 and positioned directly below the upper cutter 025, in such a way, the cutting channel 022 is defined between the upper cutter 025 and the lower clamping member 024. The lower cutter 026 is installed on the driven member 023 and located at the right of the lower clamping member 024. The upper cutter 025 and the lower cutter 026 are arranged in a staggered manner, with the second channel 021 located at the top of the upper cutter 025. The driving device 04 drives the driven member 023 to move upward, thereby bringing the lower clamping member 024 closer to the upper cutter 025, thereby narrowing the cutting channel 022. The driving device 04 continues to drive the driven member 023 upward, causing the lower cutter 026 to cut the metal wire protruding from the cutting channel 022. Before cutting, the lower clamping member 024 is close to the upper cutter 025, causing the cutting channel 022 to narrow thereby clamping the metal wire for positioning. Then, the lower cutter 026 continues to move upward, cutting off the portion of the metal wire protruding from the cutting channel 022 to obtain metal granules.

Preferably, the lower clamping member 024 is provided with a sliding cavity 0241, and the driven member 023 is provided with a connecting structure 0231 that is extended into the sliding cavity 0241. A sliding rod 0242 is installed in the sliding cavity 0241, and the connecting structure 0231 is slidably mounted on the sliding rod 0242. A spring 0243 is sleeved on the sliding rod 0242 and is positioned between the lower clamping member 024 and the connecting structure 0231. The spring 0243 constantly urges the connecting structure 0231 to slide downward. The sliding rod 0242 is served to guide and limit the movement of the driven member 023. The spring 0243 provides a cushion for the continued upward movement of the driven member 023. When the driving device 04 drives the driven member 023 upward, causing the lower clamping member 024 to move upward accordingly, the lower clamping member 024 together with the upper cutter 025 clamps the metal wire. At this point, the spring 0243 is compressed, with a small compression, and the lower cutter 026 is located below the metal wire. As the driving device 04 continues to drive the driven member 023 upward, the spring 0243 is further compressed, causing the lower cutter 026 to continue moving upward and cutting the metal wire into metal granules.

As shown in FIG. 13, a mounting slot 0251 is provided at the rear end of the upper cutter 025, and a limit plate 027 is detachably installed in the mounting slot 0251. The limit plate 027 is provided with limiting through-holes 0271 allowing for the metal wire to pass through from front to back. The metal wire entering the cutting channel 022 passes through the limiting through-holes 0271, and the limit plate 027 provides limits for the metal wire. Due to the different diameters of the metal wires, the sizes of the corresponding limiting through-holes 0271 may be different, and different limit plates 027 with different sizes may be replaced adaptively.

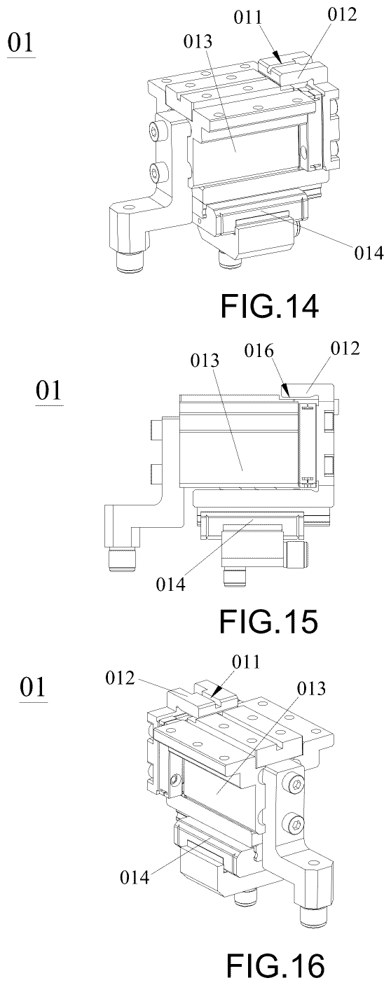

As shown in FIGS. 14 to 19, the conveyor device 01 includes an upper clamping member 012, a support base 013, and a sliding member 014. The upper clamping member 012 is slidably installed on the support base 013. A spring member 015 is installed between the upper clamping member 012 and the support base 013. A clamping channel 016 that can be expanded and narrowed is formed between the upper clamping member 012 and the support base 013, and the spring member 015 constantly tends to urge the upper clamping member 012 and the support base 013 closer to each other, thereby contracting the clamping channel 016. The upper clamping member 012 is slidably installed on the sliding member 014 in a front-to-back direction. The driving device 04 drives the sliding member 014 upward, thereby driving the upper clamping member 012 upward to expand the clamping channel 016. The driving device 04 is connected to the support base 013, and configured to drive the support base 013 to move synchronously with the upper clamping member 012 in a front-to-back direction. When the conveyor device 01 is in a relatively rear position, the upper clamping member 012 and the support base 013 are close to each other, and the clamping channel 016 is narrowed to clamp the metal wire. Simultaneously, the driving device 04 drives the conveyor device 01 to move forward. When the conveyor device 01 moves to a relatively close position, the driving device 04 drives the upper clamping member 012 upward, releasing the clamping to the metal wire. Then, the driving device 04 drives the conveyor device 01 to move backward to return to the initial position, ready for the next feeding operation.

As shown in FIGS. 2 to 19, the driving device 04 includes a drive motor 041 and a camshaft 042. The camshaft 042 is installed on the output end of the drive motor 041, and is driven to rotate by the drive motor 041. The camshaft 042 is axially arranged with a first cam 043, a second cam 044, and a third cam 045. The support base 013 is pressed against the profile of the first cam 043 through a first roller 046, the upper clamping member 012 is pressed against the profile of the second cam 044 through a second roller 047, and the driven member 023 is pressed against the profile of the third cam 045 through a third roller 048. The drive motor 041 drives the camshaft 042 to rotate, thereby pushing the conveyor device 01 for forward and backward movement via the first cam 043, pushing the upper clamping member 012 for up and down movement via the second cam 044, and pushing the driven member 023 for up and down movement via the third cam 045. The method of driving the conveyor device 01, the upper clamping member 012, and the driven member 023 by cams is the same as the prior art known to those skilled in the art and is therefore not further described here. Preferably, a reset spring 0232 is installed between the driven member 023 and the frame 300, which constantly tends to drive the driven member 023 downward, for resetting the driven member 023.

The following briefly describes the processing process of the device 1000 for flattening, conveying and cutting metal wires into granules of the present invention. First, the processing process of the flattening and feeding mechanism is described. The drive motor 041 drives the camshaft 042 to rotate, thereby pushing the conveyor device 01 for forward movement via the first cam 043, and the conveyor device 01 drives the clamped metal wire forward. At this time, the metal wire is tightened, the input guiding wheel 50 is pressed to rotate the swinging member 20, the first portion 21 makes a slight downward rotation, the second portion 22 makes a slight upward rotation, and the protrusion 23 departs from the detection opening 31, so that the photoelectric sensor 30 is triggered, thereby actuating the pressing wheel assembly 10. The driver 11 drives the worm 14 to rotate, the worm 14 accordingly drives the worm gear 15 to rotate, and the upper gear 17 and the lower gear 16 are engaged to drive, causing the upper pressing wheel 12 and the lower pressing wheel 13 to rotate relative to each other, so as to flatten the metal wire and output it. The output metal wire passes upward around the input guiding wheel 50, then downward around the guide rod 70, then around the output guiding wheel 40, and finally is output forward.

The processing process of the conveying and cutting mechanism 200 is explained. The drive device 04 drives the conveyor device 01 in a clamping state to clamp the metal wire, and drives the conveyor device 01 to convey from back to front, so as to feed the clamped metal wire into the positioning and cutting device 02. In this process, the driving device 04 drives the positioning and cutting device 02 to switch from the unclamping state to the clamping state, for clamping the metal wire. When moving downward, the fetching device 400 passes through the first channel 011 and the second channel 021, blocking the communication between the receiver 031 and the transmitter 032, thereby triggering the photoelectric sensor 03. As a result, the driving device 04 drives the positioning and cutting device 02 to switch to the cutting state, and the lower cutter 026 moves upward to cut off the metal wire extending out of the cutting channel 022 to obtain metal granules which are to be removed by the collector 400. In this process, the drive device 04 drives the conveyor device 01 to switch to the unclamping state and drives the conveyor device 01 to move forward. For a short time, the drive device 04 drives the positioning and cutting device 02 to switch to the unclamping state, instead drives the conveyor device 01 to be in the clamping state to clamp the metal wire, and drives the conveyor device 01 to translate from back to front, so that the clamped metal wire is conveyed to the positioning and cutting device 02. Repeat these steps to continuously gain the metal granules. The above process is briefly represented as steps 1-2 in FIG. 1.

As shown in FIG. 2, the direction indicated by arrow X is from front to back, the direction indicated by arrow Y is from left to right, and the direction indicated by arrow Z is from bottom to top.

In this disclosure, specific embodiments are used to explain the principle and implementation of the present application. The above embodiments are only used to assist on understanding the method of the present application and the core concept. It should be pointed out that for persons ordinarily skilled in the art, without deviating from the principle of the present application, several improvements and modifications can also be made to the present application, which also fall within the scope of protection of the claims of the present application.

What is claimed is:

1. A device for flattening, conveying and cutting metal wires into granules, comprising a flattening and feeding mechanism at a rear end and a conveying and cutting mechanism at a front end,
wherein the flattening and feeding mechanism is configured to horizontally feed a metal wire after flattened to the conveying and cutting mechanism, and the conveying and cutting mechanism is configured to advance the metal wire and cut into granules;
the flattening and feeding mechanism comprises a pressing wheel assembly, a swinging member and an output guide wheel arranged sequentially from rear to front, and a photoelectric sensor; the swinging member is rotatably arranged, and a first end of the swinging member is close to the pressing wheel assembly and equipped with an input guide wheel; the photoelectric sensor is aligned with a second end of the swinging member; the metal wire outputted from the pressing wheel assembly passes through the input guide wheel and the output guide wheel successively before entering the conveying and cutting mechanism, the swinging member is pressed and rotated as the metal wire is driven towards the conveying and cutting mechanism, and the second end of the swinging member deviates from the photoelectric sensor so as to trigger the photoelectric sensor, thereby actuating the pressing wheel assembly to flatten and output the metal wire.

2. The device according to claim 1, wherein the swinging member is bent and comprises a first portion and a second portion, the first portion is horizontally arranged, and the second portion is inclined upwards, the swinging member is pivotally mounted on a frame at a connection between the first portion and the second portion, the input guide wheel is rotatably mounted at an end of the second portion, and the photoelectric sensor is aligned with an end of the first portion.

3. The device according to claim 2, wherein an elastic member is installed between the second portion and the frame, and has a constant tendency to drive the second portion to rotate upward.

4. The device according to claim 2, wherein the flattening and feeding mechanism further comprises a guide rod positioned above the swinging member and located between the input guide wheel and the output guide wheel; the metal wire outputted by the pressing wheel assembly passes upward over the input guide wheel, then downward past the guide rod, and then upward over the output guide wheel.

5. The device according to claim 4, wherein and the guide rod is positioned directly above the connection between the first portion and the second portion, and below a line connecting the input guide wheel and the output guide wheel.

6. The device according to claim 1, wherein the input guide wheel and the output guide wheel each are provided with a receiving groove for receiving the metal wire.

7. The device according to claim 1, wherein the flattening wheel assembly comprises a driver, an upper pressing wheel, and a lower pressing wheel, with the upper pressing wheel positioned directly above the lower pressing wheel and both being close to each other; the driver is configured to drive one of the upper pressing wheel and the lower pressing wheel to rotate, and also drive the other of the upper pressing wheel and the lower pressing wheel to rotate, with the metal wire passing between the upper pressing wheel and the lower pressing wheel.

8. The device according to claim 7, wherein diameters of the upper pressing wheel and the lower pressing wheel are equal, and the upper pressing wheel is provided with an upper pressing groove and the lower pressing wheel is provided with a lower pressing groove.

9. The device according to claim 7, wherein a worm is connected to an output end of the driver, and a worm gear is installed on one side of the lower pressing wheel, for engaging with the worm for transmission.

10. The device according to claim 1, further comprising a fetching device positioned above the conveying and cutting mechanism, wherein the conveying and cutting mechanism comprises a conveyor device, a positioning and cutting device, and a photoelectric sensor; the conveyor device is configured to sequentially convey the metal wire from left to right into the positioning and cutting device, and the positioning and cutting device is configured to cut the metal wire into metal granules; the photoelectric sensor is positioned above the conveyor device and the positioning and cutting device, while the fetching device is positioned directly above the positioning and cutting device; the photoelectric sensor is triggered when the fetching device moves downward to fetch the metal wire, thereby actuating the positioning and cutting device to cut the metal wire into metal granules, which are then removed by the fetching device.

11. The device according to claim 10, wherein a top of the conveyor device is provided with a first channel, and a top of the positioning and cutting device is provided with a second channel, with the first channel and the second channel being directly connected.

12. The device according to claim 10, wherein the photoelectric sensor comprises a receiver positioned behind the conveyor device and a transmitter positioned in front of the positioning and cutting device, with the transmitter aligned with the second channel and the receiver aligned with the first channel.

13. The device according to claim 10, wherein the conveying and cutting mechanism further comprises a driving device positioned below the conveyor device and the positioning and cutting device, the driving device is configured to switch the conveyor device between clamping and unclamping states, drive the conveyor device to move forwards and backwards, and further switch the positioning and cutting device between unclamping, clamping, and cutting states.

14. The device according to claim 10, wherein the positioning and cutting device is provided with a cutting channel allowing for the metal wire to pass; the cutting channel can be expanded and narrowed, the cutting channel is expanded when the positioning and cutting device is in the unclamping state, and is narrowed when the positioning and cutting device is in the clamping and cutting states.

15. The device according to claim 14, wherein the positioning and cutting device comprises a driven member, a lower clamping member, an upper cutter, and a lower cutter, the lower clamping member is mounted on the driven member and positioned directly below the upper cutter; the cutting channel is defined between the upper cutter and the lower clamping member; the lower cutter is mounted on the driven member and located at a right of the lower clamping member; the upper cutter and the lower cutter are arranged in a staggered manner, with the second channel positioned at a top of the upper cutter; the driving device drives the driven member to move upward, bringing the lower clamping member closer to the upper cutter, thereby narrowing the cutting channel; when the driven member continues to move upward, the lower cutter is driven to cut the metal wire protruding from the cutting channel.

16. The device according to claim 15, wherein the lower clamping member is provided with a sliding cavity, the driven member is provided with a connecting structure extended into the sliding cavity, a sliding rod is installed in the sliding cavity, the connecting structure is slidably mounted on the sliding rod, the sliding rod is sleeved with a spring, the spring is located between the lower clamping member and the connecting structure, and the spring constantly tends to drive the connecting structure to slide downward.

17. The device according to claim 15, wherein mounting slot is provided at the rear end of the upper cutter, a limit plate is detachably installed in the mounting slot, and the limit plate is provided with limiting through-holes allowing for the metal wire to pass through from front to back.

18. The device according to claim 10, wherein the conveyor device comprises an upper clamping member, a support base, and a sliding member, the upper clamping member is slidably mounted on the support base, a spring member is installed between the upper clamping member and the support base, a clamping channel that can be expanded and narrowed is defined between the upper clamping member and the support base, the spring member constantly tends to drive the upper clamping member and the support base closer to each other to narrow the clamping channel, the upper clamping member is slidably mounted on the sliding member for forward and backward movements, the driving device is configured to drive the sliding member upward to move the upper clamping member upward to expand the clamping channel, and the driving device is connected to the support base and configured to drive the support base to move synchronously with the upper clamping member for forward and backward movements.

19. The device according to claim 13, wherein the driving device comprises a drive motor and a camshaft, and the camshaft is installed on an output end of the drive motor and is driven to rotate by the drive motor.

20. The device according to claim 19, wherein the camshaft is axially arranged with a first cam, a second cam, and a third cam, the support base is pressed against the first cam through a first roller, the upper clamping member is pressed against the second cam through a second roller, and the driven member is pressed against the third cam through a third roller; the drive motor drives the camshaft to rotate, thereby pushing the conveyor device for forward and backward movement via the first cam, pushing the upper clamping member for up and down movement via the second cam, and pushing the driven member for up and down movement via the third cam.
